(19) United States
(12) Patent Application Publication
(10) Pub. No.: US 2003/0199277 A1
(43) Pub. Date: Oct. 23, 2003

(54) Method and apparatus for transferring a message based on a predefined signal frame structure using a concrete syntax notation

(75) Inventors: Faical Aiouaz, Munich (DE); Norman Goris, Dortmund (DE); Michael Roy King, Axams (AT); Harald Oliver Morzinek, Rosstal (DE); Wolfgang Scheit, Rothenbach (DE)

Correspondence Address: HITT GAINES P.C., P.O. BOX 832570, RICHARDSON, TX, 75083, US

(73) Assignee: Agere Systems Inc., Allentown, PA

(21) Appl. No.: 10/379,231

(22) Filed: Mar. 4, 2003

(30) Foreign Application Priority Data
Mar. 25, 2002 (EP) 02006796.3

(51) Int. Cl. H04Q 7/20

(52) U.S. Cl. 455/450; 455/455

(57) ABSTRACT

The invention relates to the transfer of a message signal between a transmitter device and a receiver device wherein the message transfer is based on a predefined signal frame structure using a concrete syntax notation. To improve the reliability of transferring a message signal, in particular, control and/or signaling messages, at least one additional check information element is embedded within at least one unused portion of the frame structure.

### CROSS-REFERENCE TO FOREIGN APPLICATION

This application claims the benefit of EP Patent Application No. 02006796.3 entitled “A Method and Apparatus for Improving the Reliability Messages Coded by Concrete Syntax Notation,” to Faical Aiouaz, et al., filed on Mar. 25, 2002, which is incorporated herein by reference.

### FIELD OF THE INVENTION

The present invention is directed, in general, to the transfer of a message signal (or simply a message) between a transmitter device and a receiver device, wherein the message transfer, advantageously via an air interface, is based on a predefined signal frame structure using a concrete syntax notation.

### BACKGROUND OF THE INVENTION

Message signals are now commonly communicated between a transmitter unit and a receiver unit. For example, a mobile station and a base station of a mobile radio network may transfer and receive a message signal via an air interface. In a mobile radio network complying with the European Telecommunication Standard Institute (ETSI) and/or International Telecommunication Union (ITU) recommendations, such message signals may be referred to as protocol data units (PDUs).

At a transmitter unit, the PDUs are coded and transferred into a sequence of bits and forwarded to a subsequent lower protocol layer. Correspondingly, at a receiver unit, the PDUs are encoded for recovering the transferred message signals. Typically, a description of a communication or transfer protocol between a transmitter unit and a receiver unit includes a specification of the behavior in which the communication is based. For example, the description may include a specification of the transfer channels that are used.

Concrete syntax notation is a tool that may be used for the description of message signals. Originally, concrete syntax notation was designed for the specific needs of a Global System for Mobile (GSM) communication standard as a tool for the description of bit-efficient messages. In particular, concrete syntax notation 1 (CSN.1) is a notation used for the description of coding or decoding of message signals.

Though existing descriptions of message signals may increase proper transfer of message signals, reliability still needs to be improved. Unfortunately, an increase in reliability typically results in an increase in complexity of design, hardware and cost.

Accordingly, what is needed in the art is a more effective way to improve the reliability of transferring message signals without significantly adding complexity and cost.

### SUMMARY OF THE INVENTION

To address the above-discussed deficiencies of the prior art, the present invention provides a method and apparatus that improves the reliability of transferring a message based on a predefined signal frame structure using a concrete syntax notation such as CSN.1. The method and apparatus include embedding at least one additional check information element within at least one unused portion of the frame structure.

In another aspect, the present invention provides a transceiver for sending and receiving messages in a communication system. The transceiver includes an antenna and a transmitter coupled thereto that has an embedder configured to embed an additional check information element within an unused portion of a frame structure of a message to be sent via the antenna. The transceiver also includes a receiver, also coupled to the antenna, having a recoverer configured to recover an additional check information element from a message received via the antenna.

In yet another aspect, the present invention provides a communication system including a transmitter for transferring a message based on a predefined signal frame structure using a concrete syntax notation and including a means for embeddinge.(g., an embedder) at least one additional check information element within at least one unused portion of the frame structure. The communication system also includes a receiver for receiving a message based on a predefined signal frame structure using a concrete syntax notation and including a means for recovering (e.g., a recoverer) the at least one additional check information element within at least one unused portion of the frame structure.

The present invention, therefore, improves the reliability of transferring a message, in particular, including control or signaling messages, coded by a concrete syntax notation, such as the CSN.1, by embedding at least one additional check information element within at least one unused portion of the frame structure. As a result, new and considerably improved options are provides for using an already defined concrete syntax notation for a description of a coding or an encoding of message signals, thereby increasing the security against errors. Therefore, a more accurate identification of erroneous messages and, hence, a better error correction on transferred messages can be obtained.

The foregoing has outlined preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention.

### BRIEF DESCRIPTION OF THE DRAWINGS

For a more complete understanding of the present invention, reference is now made to the following descriptions taken in conjunction with the accompanying drawings, in which:

FIG. 1 illustrates a system diagram of a communication system constructed in accordance with the principles of the present invention;

FIG. 2 illustrates a block diagram schematically depicting exemplary protocol layers associated with a communication system constructed in accordance with the principles of the present invention; and

FIG. 3 illustrates a flow diagram of an embodiment of a method for transferring a message based on a predefined signal frame structure using a concrete syntax notation according to the principles of the present invention.

### DETAILED DESCRIPTION

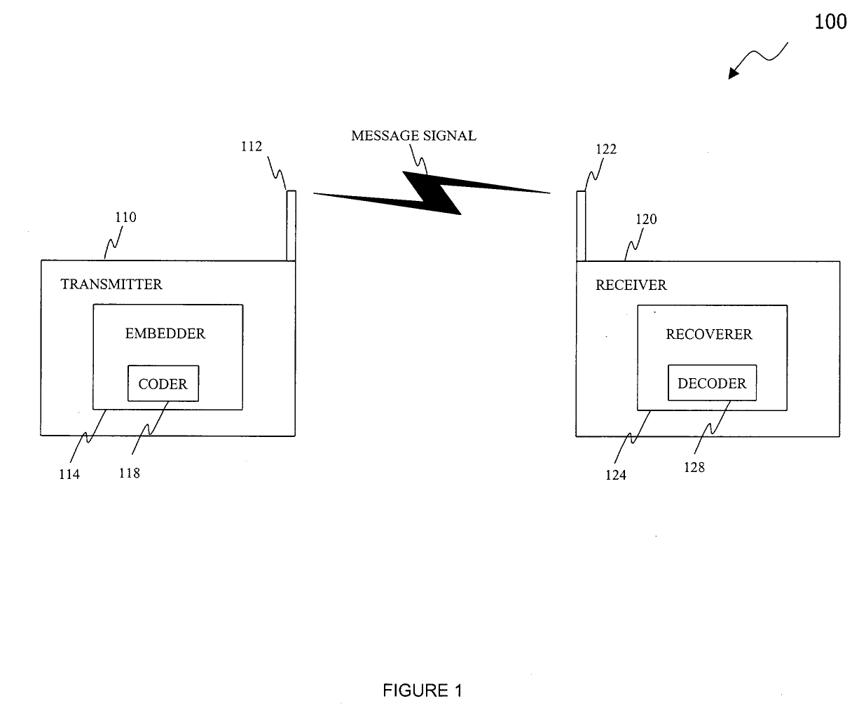

Referring initially to FIG. 1, illustrated is a system diagram of a communication system, generally designated 100, constructed in accordance with the principles of the present invention. The communication system 100 includes a transmitter 110 and a receiver 120. The transmitter 110 includes an antenna 112 and an embedder 114 having a coder 118. The receiver includes an antenna 122 and a recoverer 124 having a decoder 128.

The communications system 100 may include portions of a conventional communications system that transfers a message signal (or simply a message) by use of a frame structure or protocol between a transmitter and a receiver. In some embodiments, the communications system 100 may be a mobile radio network complying with the European Telecommunication Standard Institute (ETSI) or International Telecommunication Union (ITU) recommendations. In preferred embodiments, the communications system 100 may be a mobile communications system that employs a standard such as a Global System for Mobile communication (GSM), a General Packet Radio Service (GPRS), an Enhanced Data rate for Global System for Mobile communication Evolution (EDGE) or an Enhanced General Packet Radio Service (EGPRS) for the transfer of messages between at least one mobile station and a terrestrial communication network element. The terrestrial communication network element may be, for example, a base station.

The transmitter 110 and the receiver 120 may include portions of conventional communication devices employed within a mobile communications system that communicates messages by transferring and receiving messages between the antenna 112 of the transmitter 110 and the antenna 122 of the receiver 120 based on a predefined signal frame structure using a concrete syntax notation. One skilled in the art will understand that the transmitter 110 and the receiver 120 may be integrated into a transceiver that transfers and receives messages in the communications system 100. As previously mentioned, the transmitter 110 may be a terrestrial communication network element such as a base station and the receiver 120 may be a mobile station employed within a GSM based mobile radio network. Of course, in other embodiments, the transmitter 110 and receiver 120 may operate within a GPRS, an EDGE, or an EGPRS based mobile communications system.

The embedder 114 may be embodied in hardware or a software implementation that may be remotely adapted. The embedder 114 embeds at least one additional check information element within at least one unused portion of the frame structure. The embedder 114 may perform medium access control or radio link control for communicating between the transmitter 110 and the receiver 120. Additionally, the embedder 114 may be designed to operate on a coded frame structure with each coded frame having a bit-stream of about 23 bytes.

The additional check information element may be related to the complete message or can also be related to specific parts of the message. In some embodiments, the embedder 114 may embed the additional check information element as an additional signaling bit if there is a sufficient number of signaling bits left unused. Otherwise, the additional check information element may be in the message or a certain part of the message. Thus, the present invention is preferably complying with preexisting and widely employed frame structures having a header section and a payload section by allowing the additional check information element to be embedded within a header portion or a payload portion.

The embedder 114 may include the coder 118 (e.g., a coding means). The coder 118 further increases the reliability of transferring messages by weighting specific parts of the message. The coder may add at least one parity bit and, in addition or in the alternative, add at least one redundant bit for ensuring information redundancy with the additional check information. In some embodiments, the embedder 114 may be located physically or functionally separate from the coder 118.

The recoverer 124 may also be embodied in hardware or a software implementation that may be remotely adapted. The recoverer 124 may recover the additional check information element within at least one unused portion of the frame structure. In a preferred embodiment, the additional check information element may be configured to be used in an error identification functionality of the receiver 120 based on a physical representation or a semantic representation of the transferred message signal. This may allow additional check information elements for error identification or recovery to fill, for example, the end of the message or other unused parts of the message. By employing this type of configuration, the available physical channel capacity of the communication system 100 may be used while complying with the ETSI or ITU standardization recommendations.

The recoverer 124 may include the decoder 128. In a preferred embodiment, the decoder 128 may perform a parity check or a redundancy check on the message due to the possibility of weighting specific parts of the message using the corresponding coder 114. Weighting the message or specific parts of the message may further increase a reliability of the transfer of the message.

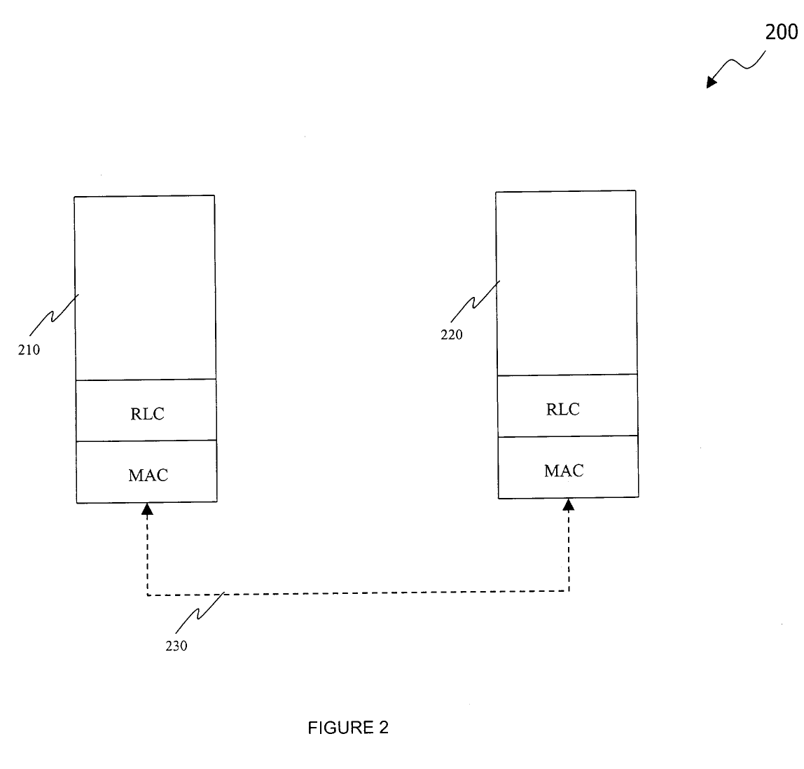

Turning now to FIG. 2, illustrated is a block diagram schematically depicting exemplary protocol layers associated with a communication system, generally designated 200, constructed in accordance with the principles of the present invention. The diagram illustrates an air interface 230 (via a broken double arrow line) of a mobile station 210 and a base station 220 of the communication system 200. The mobile station 210 and the base station 220 communicate by transferring messages through the air interface 230.

The communication system 200 may be based on a CSN.1 coded control or signaling message mobile communication system complying with the GPRS standard. The transfer of signaling messages over the air interface 230 between the mobile station 210 and the base station 220 or vice versa is generally performed according to a layer 2 protocol by radio link control functionality (RLC) and medium access control functionality (MAC).

Typically, at the air interface access layers, message data or respectively protocol data units are transferred unsupervised so that control messages coded by CSN.1 are not secured against errors. As a consequence, if at least one bit of the coded sequence of bits, usually divided in blocks or bit-streams of about 23 bytes, is toggled then the entire content of the message may be damaged. Additionally, one toggled bit may result in a wrong appointment of fine slots or the damaging of other data.

Additional information elements, however, may be added for error identification or recovery purposes on complete messages or specific message parts as described above with respect to FIG. 1. At the receiver, therefore, an error identification or recovery on the complete CSN.1 coded messages or specific parts of the messages is permitted.

Based thereon, the applying the principles of the present invention enables that the receiver may employ essentially any method or functionality for the error identification or recovery purposes. Thus, the method or specific functionality may involve a function based on a physical representation, such as a cyclic redundancy check (CRC) for example, or on a logical check of the message part values, such as a semantic representation. Since the concrete syntax notation, in particular the CSN.1, designed for specific needs of communication standards, such as GSM, GPRS, EDGE or EGPRS, is not changed by the inventive approach, the inventive approach allows full compatibility with today's but even with future specification versions of standards, e.g., the ETSI or ITU recommendations.

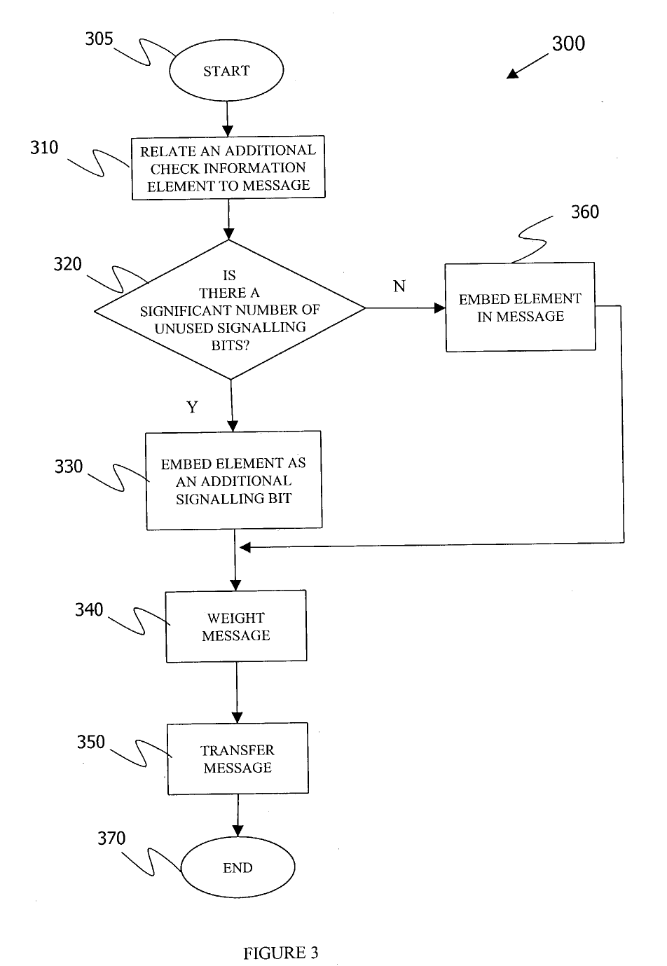

Turning now to FIG. 3, illustrated is a flow diagram of an embodiment of a method, generally designated 300, for transferring a message based on a predefined signal frame structure using a concrete syntax notation according to the principles of the present invention. The method starts in a step 305 with an intent to transfer a message. Thereafter, an additional check information element is related to the message in a step 310. The additional check information element may be related to the complete message. Advantageously, the additional check information element may also be related to specific parts of the message. In some embodiments, more than one additional check information element may be used to insure reliability.

After relating the additional check information element, a determination is made if there is a significant number of unused signaling bits in a decisional step 320. If there is a significant number of unused signaling bits, then the additional check information element is embedded as an additional signaling bit in a step 330. By employing unused signaling bits, reliability of the message transfer may be increased while also providing an easy adaptation to a respective specific application area. In a preferred embodiment, the present invention complies with frame structures having a header section and a payload section, since the additional check information element can be embedded within the header portion or the payload portion.

After the act of embedding, the message is weighted in a step 340. In some embodiments, specific parts of the message are weighted. Weighting may further increase the reliability on specific message parts by adding at least one parity bit and, in addition or in the alterative, adding at least one redundant bit for ensuring an information redundancy with the additional check information element. Additionally, due to the possibility of weighting specific parts of the message, the relative importance of the message may be signaled by means of the additional check information element resulting in a further increase of reliability thereof.

After weighting the message, the message is transferred in a step 350. In a preferred embodiment, the message is transferred between a mobile station and a terrestrial communication network element in a GSM (Global System for Mobile communication), GPRS (General Packet Radio Service), EDGE (Enhanced Data rate for GSM Evolution) or EGPRS (Enhanced General Packet Radio Service) based mobile communication system. After transferring the message, the method ends in a step 370.

Returning now to decisional step 320, if there are not a significant number of unused signaling bits, then the additional check information element is embedded in the message in a step 360. The additional check information element may be embedded in the message or in a part of the message. The additional check information element, therefore, may be advantageously adaptable in an error identification functionality of a receiver based on a physical representation or based on a semantic representation of the transferred message signal. Additionally, additional check information elements for error identification or recovery may fill, for example, the ends of the message or other unused parts of the message thereby fully using the available physical channel capacity of the communication system and, in particular, complying with the ETSI or ITU standardization recommendations. The method then proceeds and the message is weighted and transferred as described above.

While the methods disclosed herein have been described and shown with reference to particular steps performed in a particular order, it will be understood that these steps may be combined, subdivided, or reordered to form an equivalent method without departing from the teachings of the present invention. Accordingly, unless specifically indicated herein, the order and or the grouping of the steps are not necessary to comply with the principles of the present invention.

Although the present invention has been described in detail, those skilled in the art should understand that they can make various changes, substitutions and alterations herein without departing from the spirit and scope of the invention in its broadest form.

What is claimed is:

1. A method of transferring a message based on a predefined signal frame structure using a concrete syntax notation, comprising:
embedding at least one additional check information element within at least an unused portion of the frame structure.

2. The method as recited in claim 1 further comprising relating the additional check information element to a specific part of the message.

3. The method as recited in claim 1 wherein the additional check information element is embedded as an additional signaling bit.

4. The method as recited in claim 1 wherein the additional check information element is embedded within one of a header and payload portion of the message.

5. The method as recited in claim 1 further comprising providing an information redundancy by the additional check information element.

6. The method as recited in claim 1 further comprising weighting parts of the message with the additional check information element.

7. The method as recited in claim 1 wherein the additional check information element is employable by an error identification functionality based on one of a physical and semantic representation of the message.

8. An apparatus for transferring a message based on a predefined signal frame structure using a concrete syntax notation, comprising:
means for embedding at least one additional check information element within at least an unused portion of the frame structure.

9. The apparatus as recited in claim 8 wherein the additional check information element is related to a specific part of the message.

10. The apparatus as recited in claim 8 wherein the additional check information element is embedded as an additional signaling bit.

11. The apparatus as recited in claim 8 wherein the additional check information element is embedded within one of a header and payload portion of the message.

12. The apparatus as recited in claim 8 further comprising coding means for adding at least one of a parity bit and a redundant bit.

13. The apparatus as recited in claim 8 further comprising coding means for weighting parts of the message.

14. The apparatus as recited in claim 8 wherein the additional check information element is employable by an error identification functionality based on one of a physical and semantic representation of the message.

15. A transceiver capable of transferring a message based on a predefined signal frame structure using a concrete syntax notation, comprising:
an embedder configured to embed at least one additional check information element within at least an unused portion of the frame structure; and
a recover configured to recover at least one additional check information element within at least an unused portion of the frame structure.

16. The transceiver as recited in claim 15 wherein the additional check information element is related to a specific part of the message.

17. The transceiver as recited in claim 15 wherein the additional check information element is embedded as an additional signaling bit.

18. The transceiver as recited in claim 15 wherein the additional check information element is embedded within one of a header and payload portion of the message.

19. The transceiver as recited in claim 15 further comprising a coder configured to add at least one of a parity bit and a redundant bit.

20. The transceiver as recited in claim 15 further comprising a coder configured to weight parts of the message.

21. The transceiver as recited in claim 15 further comprising a decoder configured to perform at least one of a parity check and a redundancy check.
